(19) United States
(12) Patent Application Publication
(10) Pub. No.: US 2012/0255399 A1
(43) Pub. Date: Oct. 11, 2012

(54) Angular oil filter cartridge wrench

(76) Inventor: Damian Francisco Caraballo, Royal Palm Beach, FL (US)

(21) Appl. No.: 13/066,162

(22) Filed: Apr. 8, 2011

(51) Int. Cl. B25B 13/04

(52) U.S. Cl. 81/124.3

(57) ABSTRACT

An angular, one-piece, box-end wrench specifically designed to access and grip onto the oil filter Dorman filler cap of the newly designed General Motor (GM) combustion engines, more specifically the GM 2.2L and 2.4L ECOTEC 1-4 engines, comprising of a handle grip, a handle shaft and a box-end wrench. The inventive device includes a handle grip with a 90 degree perpendicular bend forming an elongated handle shaft with a second 100 degree bend distally spaced and opposite to the handle grip accommodating a hex box-end body sized to fit and access the above stated GM oil filter cartridges for maintenance and replacement.

### CROSS REFERENCE TO RELATED APPLICATIONS

Not applicable to this application.

### STATEMENT REGARDING FEDERALLY SPONSORED RESEARCH OF DEVELOPMENT

Not applicable to this application.

### BACKGROUND OF THE INVENTION

1. Field of the Invention

The present invention relates generally to an oil filter cartridge wrench used to access oil filter cartridges for maintenance and replacement and more particularly to a one-piece, multi-angled, box-end wrench designed specifically to access the hard-to-reach location of the latest engineered General Motors (GM) combustion engine oil filter cartridge end cap.

2. Description of the Prior Art

Because of the innovation in automotive engine designs, tools are constantly evolving to keep up with these advances. In this particular case, various models of the latest engineered General Motors combustion engines, most specifically the GM 2.2L and 2.4L ECOTEC 1-4 engines, have relocated their oil filter cartridges to the top of the engine. In this process of relocation, the oil filter cartridge has been positioned in a very space restricted area on the top of a generally ten degree slanted engine top-surface. Because of this novel engine design, the oil filter cartridge is inaccessible for most inexpensive hand tools available. In addition, standard wrenches needed to engage the large 1.25 inch hex nut on the oil filter Dorman filler cap do not have the capability to physically reach the new GM oil filter cap hex nut unaided without other additional tools.

Due to the large dimension of the oil filter Dorman filler cap hex nut end, its location on the slanted 10 degree engine top-surface and the distance to it, presently the least expensive and most convenient way to access said hex nut is to use a ratchet wrench with an extension tool coupled to a universal joint and a low profile socket. This combination wrench tool is very expensive to obtain for the one simple task of accessing the oil filter cartridge, and thus the one-piece, angular oil filter wrench is designed as a tool to inexpensively and efficiently perform said task.

There are numerous combination angular box-end wrenches that have been disclosed and have appeared on the market. For example, U.S. Pat. No. 3,186,265 to Anthony J. Wenturine; U.S. Pat. No. 6,148,698 to Chih-Ching Hsieh are illustrative of such prior art.

Wenturine (U.S. Pat. No. 3,186,265) discloses a ratchet type socket wrench having angularly adjustable auxiliary handles.

Chih-Ching (U.S. Pat. No. 6,148,698) discloses an angle-adjustable, box-end wrench which can be adjusted to change the angular position of the box-end and to hold the box-end in the adjusted position positively.

While these devices may be suitable for the particular purpose to which they address, they are not suitable for providing the correct angle placement nor have the box-end wrench dimension necessary for accessing the new GM oil filter cartridge Dorman filler cap hex nut. Additionally, these tools are also not long enough to reach the filter cartridge location for proper contact and grip.

In these respects, the present invention substantially departs from the conventional concepts and designs of the prior art, and in so doing provides a compact, one-piece, lightweight, proficient tool specifically developed for the purpose of efficiently, inexpensively and easily accessing these new, relocated oil filter cartridges found in the modern General Motors combustion engines.

### BRIEF SUMMARY OF THE INVENTION

In view of the foregoing disadvantages inherent in the known overly expensive and cumbersome apparatus now present in the prior art, the general purpose of the present invention, which will be described subsequently in greater detail, is to provide a new tool construction with novel features, wherein the same can be utilized for efficiently facilitating the installation and replacement of certain, not easily accessible oil filter cartridges for many new General Motors (GM) engines, most specifically the GM 2.2L and 2.4L ECOTEC 1-4 engines.

To attain this, the present invention generally comprises of a single unit composed of a handle grip designed with a 90 degree downward bend that forms an elongated handle shaft which terminates in its opposite end with a large, box-end hex nut wrench application that is uniquely angled 100 degrees away from the tool handle shaft base in order to accommodate the size, angle placement and distance of said oil filter cartridges.

There has thus been outlined, rather broadly, the more important features of the invention in order that the present contribution to the art may be better appreciated.

There are additional features of the invention that will be described herein after and that will form the subject matter of the claims appended hereto. In addition to the primary objective to provide a single, cost-efficient tool to facilitate the replacement of said GM oil filter cartridges, additional advantages of the invention include its durability, reduced weight and user-friendly design.

This invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a lateral view of the present invention preparing to engage an oil-filter dorman filler cap found in GM 2.2L and 2.4L ECOTEC 1-4 engines.

FIG. 2 is a top view of the present invention.

FIG. 3 is a rear view of the present invention.

FIG. 4 is a front view of the present invention.

### DETAILED DESCRIPTION OF THE INVENTION

### Overview:

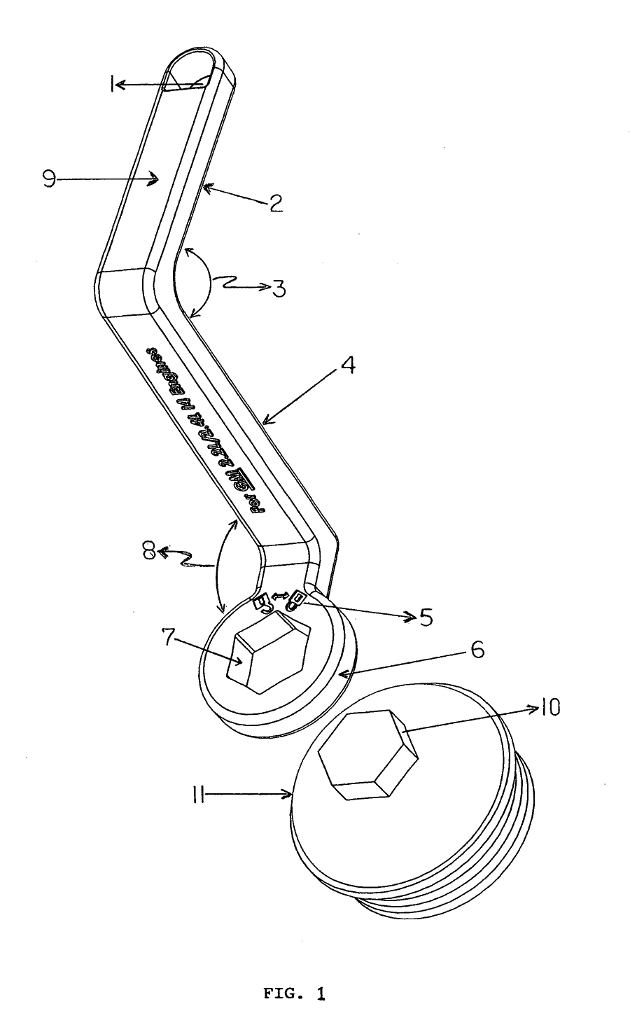

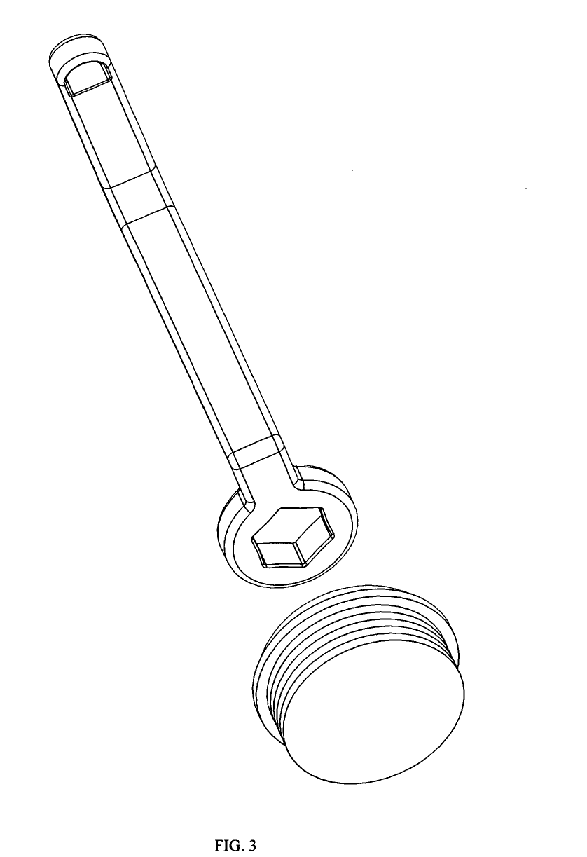

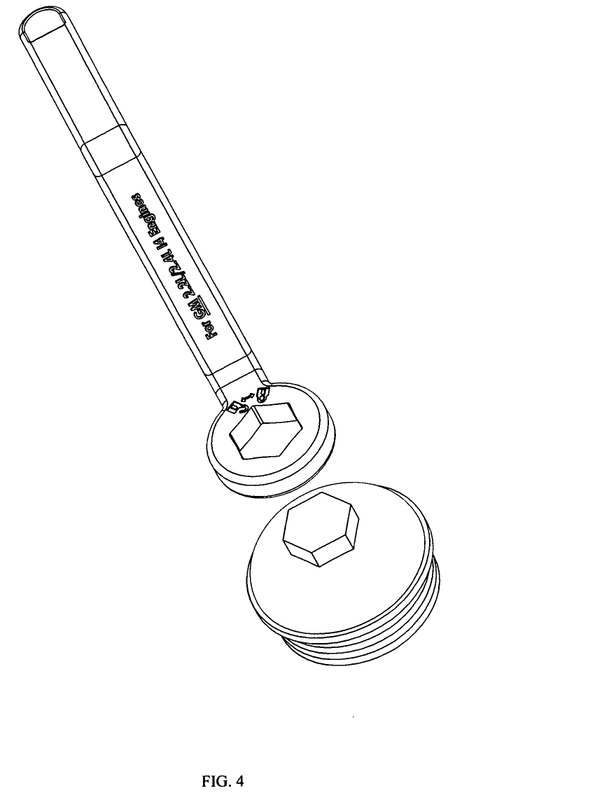

Turning now descriptively to the drawings, in which similar reference characters denote similar elements throughout the several views, FIGS. 1 through 4 illustrate a one-piece, angular oil filter cartridge wrench comprised of a handle with an elongated shaft angled 90 degrees relative to the handle, and terminating in a 100 degree angled box-end wrench with a hex nut aperture designed to engage the oil-filter Dorman filler cap of the oil-filter cartridge of the GM 2.2L and 2.4L ECOTEC 1-4 engines.

### DRAWINGS

All drawings enclosed are in reference to the Angular Oil Filter Wrench designed for General Motors 2.2L and 2.4L ECOTEC 1-4 engines.

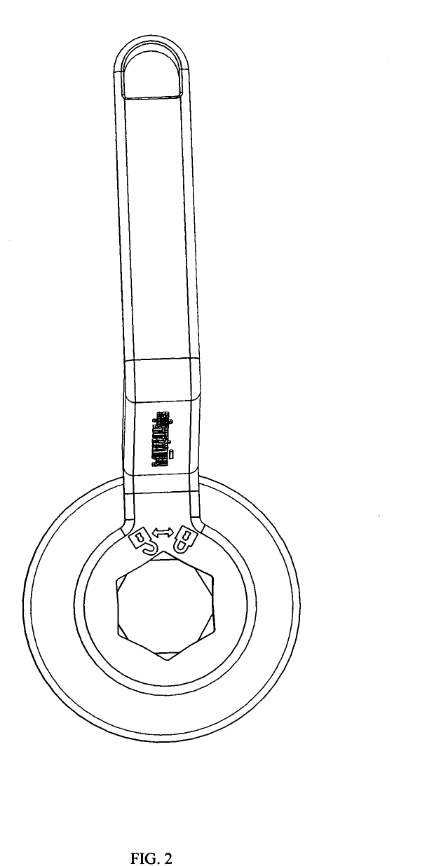

The following is a brief description of the drawing reference characters found in FIG. 1 and pictorially corresponding to FIGS. 2 through 4:

### FIG. 1 Legend:

1. Wrench hanging aperture
2. Wrench handle grip
3. Wrench handle 90 degree angle
4. Wrench shaft
5. Universal icons symbols for “Lock” and “Unlock”
6. Wrench box-end body
7. Wrench box-end hex nut aperture
8. Wrench box-end 100 degree angle away from handle shaft
9. Angular Oil Filter Cartridge Wrench
10. Oil filter Dorman filler cap hex nut
11. Oil filter Dorman filler cap

### DESCRIPTION OF THE PREFERRED EMBODIMENT

Hereinafter, the present invention is described more fully with reference to the accompanying drawings in which the preferred embodiment of the invention is depicted.

The invention is preferably fabricated out of high strength plastic reinforced with nylon material in one continuous piece that serve the functions of price efficiency and light weight with sufficient strength for torque; however, other materials may be used including metals such as chromium-vanadium alloy tool steels.

Referring to FIG. 1 and pictorially corresponding to FIGS. 2 to 4 which denote similar elements throughout the several views, the Angular Oil Filter Cartridge Wrench 9 in accordance with the present invention is a one-piece tool generally comprised of a handle grip 2, a handle shaft 4, and a box-end wrench 6. The handle grip 2 includes an inverse u-shaped aperture 1 in order to facilitate hanging and storage of the wrench, positioned at its point of origin. The handle grip 2 is approximately 5 inches in length in order to comfortably accommodate an adults' hand and form a proper grip for the tool. The handle grip 2 curves into a 90 degree angle bend 3, vertically forming the elongated handle shaft 4 portion of the wrench. The handle shaft 4 surface has imprinting, denoting the engine type applicable to the wrench.

The handle shaft 4 is elongated to approximately 6.25 inches in length in order to reach and contact the recessed oil filter Dorman filler cap 11 and terminates in a box-end wrench 6 which extends horizontally away from the handle shaft 4 axis in a 100 degree angle bend 8. The box-end hex nut aperture 7 is sized to fit snugly onto the oil filter Dorman filler cap hex nut 10, which in this embodiment is 1.25 inches. The box-end wrench 6 is imprinted with the universal icon symbols 5 for “Lock” and “Unlock” denoting the direction in which to turn the wrench handle grip 2 when utilizing the wrench in removing or installing the oil filter Dorman filler cap 11 as illustrated in FIG. 1.

The use of the Angular Oil Filter Cartridge Wrench 9 is simple as noted in the previous paragraph by the explanation of the universal icon symbols 5. The wrench 9 is accommodated and placed directly on top of the oil filter Dorman filler cap 11 and the oil filter Dorman filler hex nut 10 is fitted onto the wrench box-end hex nut aperture 7 and securely engaged. The handle grip 2 is turned counter-clockwise to unlock the oil filter Dorman filler cap 11 to access it for removal, and clockwise to lock it in place for installation.

I claim:

1. An angular, one-piece, box-end wrench designed to access and grip onto the oil filter Dorman filler cap of the newly designed General Motor (GM) combustion engines, more specifically the GM 2.2L and 2.4L ECOTEC 1-4 engines, comprising of a handle grip, a handle shaft and a box-end wrench.

2. An angular, one-piece, box-end wrench of claim 1, wherein said handle grip includes an inverse, u-shaped aperture suitable for hanging said wrench, positioned at its point of origin and wherein said handle grip is of finite length from its point of origin for suitable convenience of grasp and wrench manipulation and said handle grip of said finite length bends at an angle of 90 degrees perpendicular to the longitudinal axis of said handle grip to form the longitudinal axis of said handle shaft.

3. An angular, one-piece, box-end wrench of claim 2, wherein said handle shaft is of finite and sufficient length to attain the reach and contact of said oil filter Dorman filler cap and wherein said longitudinal axis of said handle shaft of said finite length bends horizontally at an angle of 100 degrees relative to the front of said handle shaft and terminates to form a box-end wrench in order to accommodate and couple onto said oil filter Dorman filler cap.

4. An angular, one-piece, box-end wrench of claim 3, wherein said box-end wrench is constructed with a hex nut aperture of a suitable dimension to securely fasten and grip onto said oil filter Dorman filler cap unique to its application, and which said box-end wrench can be manufactured in a plurality of dimensions to accommodate a plurality of models.

5. An angular, one-piece, box-end wrench of claim 4, wherein said box-end wrench is imprinted on its top surface positioned in nearest proximity to said handle shaft of claim 3 with the universal icon symbols for “Lock” and “Unlock” in order to facilitate the direction in which to turn the said handle grip of claim 2 when in use to access the oil filter Dorman filler cap.
